(19) United States
(12) Patent Application Publication
(10) Pub. No.: US 2004/0123331 A1
(43) Pub. Date: Jun. 24, 2004

(54) Cold boot timing

(76) Inventor: Kevin Jackman, March (GB)

Correspondence Address: Francis I. Gray, TEKTRONIX, INC., MS 50-LAW, P.O. Box 500, Beaverton, OR, 97077, US

(21) Appl. No.: 10/661,313

(22) Filed: Sep. 12, 2003

(30) Foreign Application Priority Data
Oct. 2, 2002 (GB) 0222829.4

(51) Int. Cl. H04N 7/16; H04N 7/173

(52) U.S. Cl. 725/131; 725/151; 725/139; 725/107

(57) ABSTRACT

A nominal cold boot time for an application from a Multimedia Home Platform (MHP) transport stream containing an Application Information Table (AIT) is monitored at selected starting positions in the transport stream. Following indication of an application, a Service Gateway and AIT are received and analyzed to identify assets in the transport stream required by the application. Occurrences of the assets are downloaded from the transport stream in the order in which they are received. The time from the selected starting position to the receipt of the last asset required for the application is output as the nominal cold boot time for the selected starting position in the transport stream.

### BACKGROUND OF THE INVENTION

The present invention relates to monitoring of compressed video signals, and more particularly to determining cold boot timings for applications transmitted in a compressed video transport stream such as a Multimedia Home Platform (MHP) stream.

Digital Video Broadcasting (DVB) compressed video transport streams may contain Object Carousels to make data files available to a DVB receiver. These data files typically contain either applications for running on the DVB receiver or data that is referenced by the applications. One or more Object Carousels may be carried within a DVB multiplexed transport stream in the same way as video and audio streams. The transport stream may contain one or more services and each of the services may contain one or more Object Carousels. The services may be identified by a Program Application Table (PAT), a Program Map Table (PMT) and Service Information (SI).

Each Object Carousel has a service gateway which is a root directory of a file system of assets delivered by the Object Carousel and must be acquired before any other object can be downloaded. Any asset belonging to the Object Carousel appears in the service gateway, i.e. a root asset and remaining assets are contained in the Object Carousel. The root asset then must be downloaded followed by all remaining assets or objects. Where the application is a Java application, the root asset is a boot class. A manner in which assets may be identified from the service gateway is defined in the MPEG specification ISO/IEC 13818-6:1998: “Information technology—Generic coding of moving pictures and associated audio information—Part 6: Extensions for DSM-CC”.

The way in which the hierarchical structure of the service gateway is transmitted affects the order of acquisition of the assets. This means that assets are only capable of being downloaded when the full path to the assets has been received. The assets are contained in modules in the transport stream.

Therefore many sections containing modules have to be received in a specific order from the transport stream before a section containing the content required is located in the transport stream. A set-top box does not pay attention to modules received in the transport stream unless the set-top box knows the modules' content is of interest. The set-top box only knows a module containing an asset is of interest when the asset is identified in the service gateway. The set-top box then has to wait for the next occurrence of this module, starting at the time that the section identifying the asset was received.

Cold boot timing is known for enabling a user to observe how long it takes a receiver, such as a set-top box, to download, in order, from the transport stream all of the data associated with a given application, assuming that the receiver has just been switched on and the receiver does not have any previously retained information. By repeating this calculation at intervals along the transport stream being analyzed, the user determines a series of different cold boot timings, dependant on when the set-top box is nominally switched on.

A Multimedia Home Platform (MHP) may be defined by a DVB standard for the transmission of enhanced and interactive applications for digital television, for example. Such an open standard is European Telecommunications Standards Institute TS 101812 “Digital Video Broadcasting (DVB); Multimedia Home Platform (MHP) Specification” available from ETSI, 650 Route des Lucioles, F-06921 Sophia Antipolis Cedex-France. MHP applications may be transmitted in a transport stream as pre-compiled Java programs, with MHP receivers incorporating a Java virtual machine which is able to run the MHP applications by decoding relevant file objects transmitted in the transport stream. Alternatively, an application may be, for example, an HTML page or set of pages. However, for MHP applications the cold boot timing described above is inaccurate. An Application Information Table (AIT) is transmitted with or within an Object Carousel carrying MHP applications. The AIT provides information to the DVB receiver decoder about the data services and a required activation state of each MHP application carried. Cold boot timings for MHP transport streams therefore have to include the time to download the AIT. The AIT contains a description of the root asset. Using the AIT, an MHP set-top box does not need to know anything about an application before it is transmitted. By reading the AIT the set-top box obtains an application name, the Object Carousel the application is associated with, the root asset or boot class, and its activation state, i.e. whether the application should be run immediately, should wait for a stimulus, or is to be removed. The AIT may also carry pre-fetch information, which enables modules that are related to the application to be identified. The set-top box may then store first occurrences of these modules which are received, until they are referred to, when the set-top box can interpret the stored modules, rather than waiting for the next transmission of an occurrence of the module. Thus, the pre-fetch information indicates which modules are relevant to an MHP application. The boot process then acquires the modules in parallel with locating the assets via a hierarchical tree. It could be possible for all of the modules to be pre-fetched before the complete tree required by the application has been built. In general, this significantly decreases the cold boot timing.

What is desired is to obtain cold boot timings for MHP applications which more accurately reflect the time a set-top box, for example, needs before an application becomes available.

### BRIEF SUMMARY OF THE INVENTION

According the present invention provides a method and apparatus for monitoring a nominal time to boot an application from a Multimedia Home Platform (MHP) transport stream containing an Application Information Table (AIT) A start position in the transport stream is selected and a start time is recorded. A service having an Object Carousel and an associated AIT is identified in the transport stream. Then a next occurrence in the transport stream of the associated AIT section for the application is received. The AIT section is analyzed to determine a root asset and all remaining assets required by the application. A next occurrence in the transport stream of a module containing the root asset and subsequent occurrences in the transport stream of modules containing all remaining determined assets for the application respectively are received and the time of receipt of the last such module is recorded as a finish time. The nominal cold boot time is determined by subtracting the start time from the finish time.

Advantageously, determining the nominal cold boot time includes outputting a signal representative of the determined nominal cold boot time to a user interface, and also includes selecting a new start position in the transport stream and recording a new start time to determine a succeeding cold boot timing. The outputting of the determined nominal cold boot times to the user interface includes graphically displaying the successive cold boot timings. Determining the nominal cold boot time may also include modifying the transport stream by varying an AIT repetition rate in the transport stream to vary the nominal cold boot time.

Advantageously, analyzing the AIT section includes detecting incorrect or insufficient AIT information in the AIT section properly to download the application and outputting a warning signal. Detecting incorrect or insufficient AIT information includes detecting an inability to boot the application because of the incorrect or insufficient AIT information.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

The invention is described, by way of example, with reference to the accompanying drawings, in which:

FIG. 1 is a graphical illustration of elements of a transport stream for which cold boot timings are obtained according to the prior art;

FIG. 2 is a graph of cold boot time as ordinates and data stream time as abscissa for the transport stream of FIG. 1;

FIG. 3 is the graph of FIG. 2 extended over a longer period of time;

FIG. 4 is a graphical illustration of elements of a MHP transport stream for which cold boot timings are obtained according to the invention;

FIG. 5 is a graph of cold boot time as ordinates and data stream time as abscissa for the MHP transport stream of FIG. 4; and

FIG. 6 is a state transition diagram of the invention.

### DETAILED DESCRIPTION OF THE INVENTION

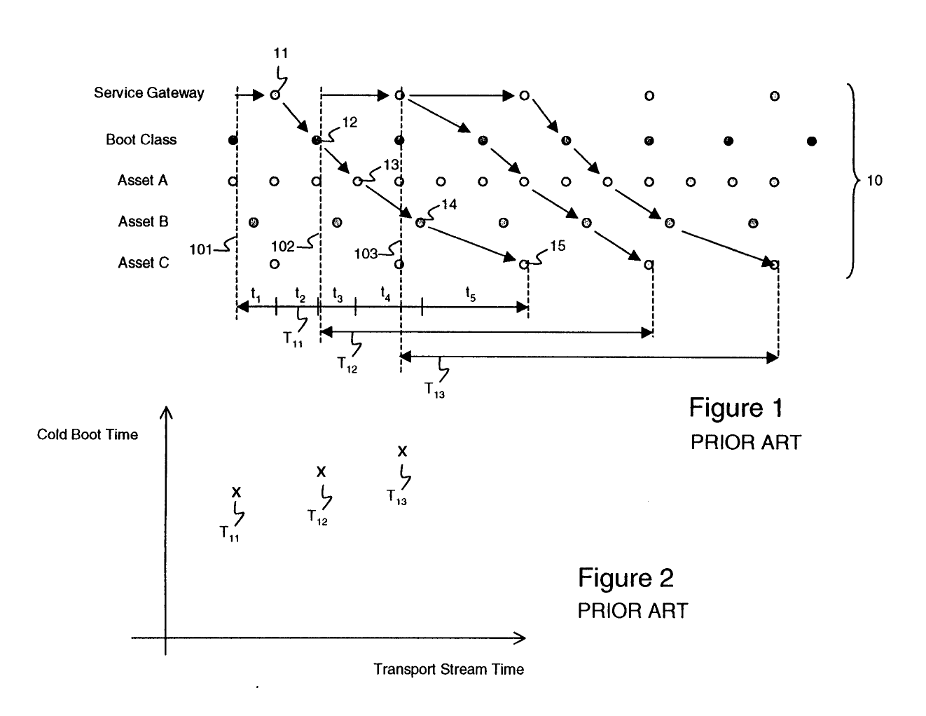

The elements of an application transmitted in a typical multi-service, multi-application transport stream 10 of the prior art are illustrated in FIG. 1, in which occurrences of each of the elements or modules are cyclically transmitted, typically with different cycle frequencies, within the transport stream. The elements are shown for the purposes of illustration only as regularly spaced within the stream.

Cold boot timing allows a user to observe how long it takes a set-top box to load from a transport stream all of the data associated with a given application, assuming that the set-top box had just been switched on and did not have any previously retained information, i.e. a cold boot. Typically, this calculation is performed at intervals along the stream being analyzed. This means a user can see a series of different scenarios, depending on when the set-top box is (theoretically) switched on. In practice, an Object Carousel is identified and one or more applications to be timed are selected from a current application list. As each application is selected, software of a monitor checks the availability of the associated root asset and other assets.

As shown in FIGS. 1 and 2, in the prior art all the assets are received in a predetermined order. Thus starting from a selected position 101 in the transport stream at which a receiver nominally seeks to start to download an application, the first occurrence of a service gateway 11 of the application is received by a monitor in a stream time t₁. After receipt of the service gateway, the next occurrence of a root asset or boot class 12 is received in a further time t_{2,} since the boot class must be downloaded before any of the other assets. This is because this timing method assumes no signaling caching. This simulates a set-top box not knowing which Carousel Objects or assets the boot class uses until the set-top box has completely received and processed the boot class asset. The boot class 12 has assets A, B and C. If assets A and B are directories, this implies that there is a precedence in the order in which occurrences 13,14,15 of the assets may be downloaded. The transport stream is received until after a further time t₃ the first occurrence 13 of asset A is received. The next occurrence 14 of asset B is received in a further time t₄ and the next occurrence 15 of asset C in the transport stream is received in a further time t₅. Since assets are transmitted in modules, the end of each cycle actually is the end of the module containing the last asset. If assets A, B and C identified files, then there is no interdependence. That is, the cold boot timing attempts to locate the files simultaneously. Therefore there are implied rules of precedence, dependent on a way in which the hierarchical tree structure is transmitted.

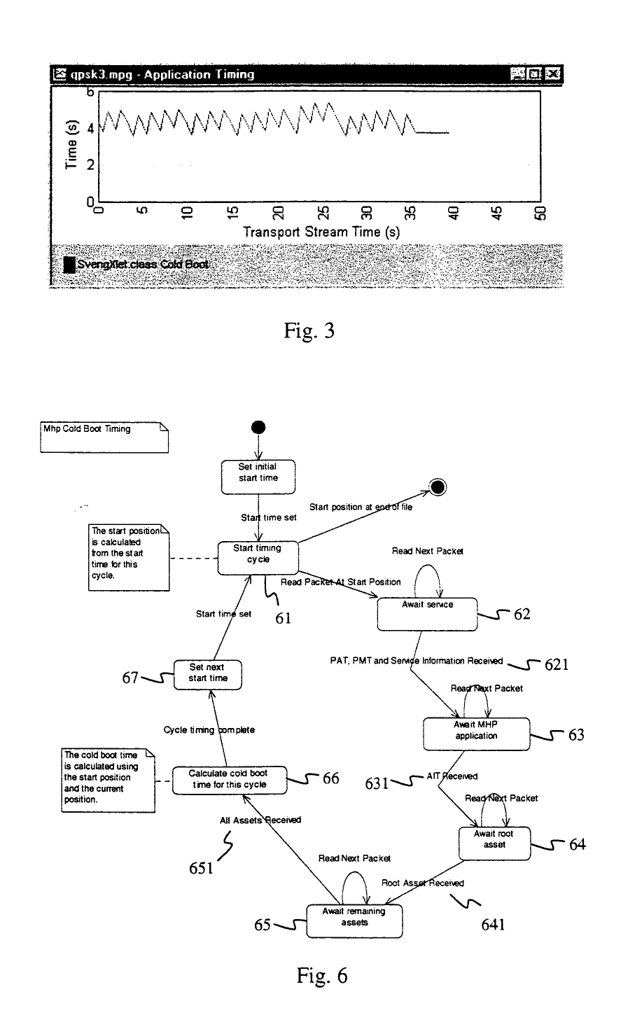

One occurrence of each of the assets of the application having been received, the cold boot time T₁₁ starting at the selected position in the transport stream is calculated as the sum of t₁, t₂, t₃, t₄ and t₅. The value T₁₁ of the cold boot time may be plotted on a graph as shown in FIG. 2. As shown in FIGS. 1 and 2, further values, for example T₁₂ and T₁₃, of the cold boot time may be obtained by starting at different selected positions 102, 103 respectively in the transport stream. The user may define a ‘sampling’ frequency; that is intervals at which to start the nominal download and observe how long it takes to signal the Object Carousel and download the service gateway, the boot class and all of the assets. For example, in a 60 second stream, an interval of five seconds samples the download, or cold boot, time twelve times. As shown in FIG. 3, a plot of cold boot time may thus be obtained for positions throughout the transport stream for monitoring the transport stream.

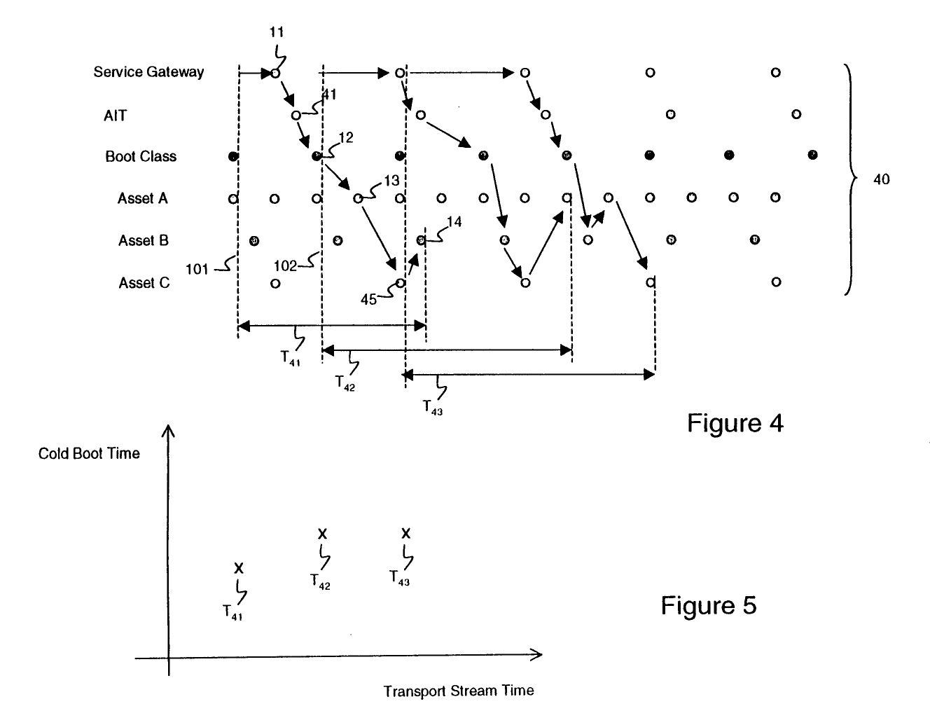

In contradistinction to the prior art method described above, in the present invention the AIT is also received and data from the AIT is used to determine the effect of pre-fetching assets other than the boot class. Thus, referring to FIGS. 4 and 5 starting at an equivalent selected position 101 in an MHP transport stream 40, after the Service Gateway 11 and first occurrence 41 of the AIT for the chosen application are received by a monitor, the monitor is aware of an interest in the modules that convey the boot class and the assets A, B and C so that the time is calculated to download first the first occurrence 12 of the boot class and then the first occurrences 13, 45, 14 of the other assets in an order in which they are received. It is apparent that in general this results in a shorter cold boot time T₄₁ than the cold boot time T₁₁ measured in the prior art, and such cold boot time monitoring for MHP applications more accurately reflects the amount of time a set-top box needs before the application becomes available, using the pre-fetch facility of the AIT of an MHP transport stream.

Referring to FIG. 6, the method may be illustrated by a state diagram, in which a position is selected, step 61, in the transport stream at which the cold boot time is to be calculated and a timing cycle started. Packets of the transport stream are read, step 62, until a Service, identified by a Program Application Table (PAT), a Program Map Table (PMT) and Service Information (SI) is received, step 621. Succeeding packets of the transport stream are read, step 63, until an AIT of the predetermined application is received, step 631. The AIT is analysed to determine the root asset necessary to the application. Succeeding packets of the transport stream are read, step 64, until the root asset, or, in the case of a Java application boot class, for the predetermined application is received, step 641. Succeeding packets of the transport stream are read, step 65, until all the remaining assets of the predetermined application have been received, step 651, in an order in which next occurrences of each asset occur in the transport stream. The cycle time for a cold boot start is calculated from the start time and the time to receive the last of the assets of the application. The procedure is restarted, step 67, for a new position in the transport stream. Thus the AIT information is analyzed and related to the applications in the stream. A connection is made between the application and the AIT that signals its presence.

In addition, the procedure may draw the user's attention to any errors in the stream. If the AIT information in the stream has not been generated correctly, the cold boot timing is severely affected. It may even be apparent that the set-top box is incapable of cold booting, due to the omission of correct AIT information. For example, an asset may be expected by an application but not be present in the service gateway. Alternatively, an asset may be identified in the service gateway but not be transmitted in any module in the transport stream. In both cases a failure is indicated in the cold boot process.

The procedure may also enable the user to analyze a relationship between the AIT and a particular application. The frequency with which the AIT is repeated in the stream may severely affect the cold boot time. The user may use the cold boot timing information to fine tune a test stream to improve the cold boot time for the particular application.

Although the invention has been described in relation to MHP transport streams containing AIT tables for determining cold boot timings, the present invention has applicability to any transport stream containing a module identifying all other modules relevant to, for example, an application, program or service, and to the calculation of other boot or download timings than cold boot timings.

What is claimed is:

1. A method of monitoring a nominal cold boot time for an application from a Multimedia Home Platform (MHP) transport stream containing an Application Information Table (AIT) comprising the steps of:
a) recording a start time for a selected start position in the transport stream;
b) identifying after the selected start position in the transport stream a service having an Object Carousel and an associated AIT section;
c) receiving a next occurrence after the service in the transport stream of the associated AIT section for the application;
d) analyzing the associated AIT section to determine a root asset and remaining assets required by the application;
e) receiving after the associated AIT section in the transport stream a next occurrence of a module containing the root asset and subsequent occurrences of modules containing the remaining assets, recording a time of receipt of the last such module as a finish time; and
f) determining the nominal cold boot time by subtracting the start time from the finish time.

2. The method as recited in claim 1 wherein the determining step comprises the step of outputting a signal representative of the nominal cold boot time to a user interface.

3. The method as recited in claim 2 further comprising the steps of:
recording a new start time in the transport stream for a new selected start position; and
repeating steps b) to f) for the new start position to determine a succeeding nominal cold boot time.

4. The method as recited in claim 3 wherein the outputting step comprises the step of graphically displaying the nominal cold boot times.

5. The method as recited in claim 1 wherein the analyzing step comprises the steps of:
detecting incorrect or insufficient AIT information in the AIT section to properly download the application; and
outputting a warning signal.

6. The method as recited in claim 5 wherein the detecting step comprises the step of detecting an inability to boot the application because of the incorrect or insufficient AIT information.

7. The method as recited in claim 1 further comprising the step of modifying the transport stream by varying an AIT repetition rate in the transport stream to vary the nominal cold boot time.

8. A monitor for monitoring a nominal cold boot time for an application from a Multimedia Home Platform (MHP) transport stream containing an Application Information Table (AIT), the monitor comprising:
means for recording a start time for a selected starting position in the transport stream;
means for identifying after the selected starting position in the transport stream a service having an Object Carousel and an associated AIT section;
means for successively identifying modules after the service in the transport stream having a next occurrence of the associated AIT section for the application and succeeding occurrences of a root asset and remaining assets of the application;
means for analyzing the AIT section to determine the root asset and remaining assets of the application and for informing the module identifying means that the module identifying means may identify the succeeding occurrences of the assets in the transport stream in an order in which they are received; and
means for measuring the nominal cold boot time as the difference between the start time and a time of receipt of all the assets for the application.

9. The monitor as recited in claim 8 further comprising means for outputting a signal representative of the nominal cold boot time to a user interface.

10. The monitor as recited in claim 9 wherein the outputting means comprises a visual display arranged graphically to display the nominal cold boot time.

11. The monitor as recited in claim 8 wherein the analyzing means comprises:
means for detecting incorrect or insufficient AIT information in the AIT section for proper downloading of the application; and
means for outputting a warning signal.

12. The monitor as recited in claim 11 wherein the analyzing means further comprises means for detecting an inability of the application to boot because of the incorrect or insufficient AIT information.
